(19) United States
(12) Patent Application Publication
(10) Pub. No.: US 2025/0129958 A1
(43) Pub. Date: Apr. 24, 2025

(54) CONTROL APPARATUS, CONTROL SYSTEM, CONTROL METHOD, AND STORAGE MEDIUM

(71) Applicant: NEC Corporation, Minato-ku, Tokyo (JP)

(72) Inventors: Yuta Namiki, Tokyo (JP); Jianquan Liu, Tokyo (JP); Satoshi Yamazaki, Tokyo (JP); Noboru Yoshida, Tokyo (JP); Ryo Kawai, Tokyo (JP); Tingting Dong, Tokyo (JP); Karen Stephen, Tokyo (JP); Naoki Shindou, Tokyo (JP); Youhei Sasaki, Tokyo (JP)

(73) Assignee: NEC Corporation, Minato-ku, Tokyo (JP)

(21) Appl. No.: 18/730,399

(22) PCT Filed: Feb. 1, 2022
(86) PCT No.: PCT/JP2022/003756

§ 371 Date: Jul. 19, 2024

(51) Int. Cl. F24F 11/50; F24F 120/20; G06F 3/01; G06V 40/20; G10L 17/02; G10L 17/06

(52) U.S. Cl. CPC F24F 11/50; G06F 3/017; G06V 40/20; G10L 17/02; G10L 17/06; F24F 2120/20

(57) ABSTRACT

A control apparatus (103) includes a detection unit (104), and a control unit (105). The detection unit (104) detects a predetermined first gesture by processing image information. When an input condition being a condition for allowing control of a device (102) using the first gesture is satisfied, the control unit (105) controls the device (102) according to the first gesture.

### TECHNICAL FIELD

The present invention relates to a control apparatus, a control system, a control method, and a program.

### BACKGROUND ART

Various techniques for controlling an electrical device in response to a motion of a person have been proposed.

For example, in Patent Document 1, an indoor unit 100 of an air conditioner is described in which, when a user U1 makes a predetermined motion (1 in S1), a control apparatus 70 determines the motion of the user U1 (2 in S1), recognizes that a gesture instruction condition is instructed (3 in S1), and controls a heat exchanger 4 and the like according to the gesture instruction condition (4 in S1).

For example, an air conditioning system 1 according to Patent Document 2 recognizes a change request for an air conditioning setting from a user through a gesture input operation, and adjusts airflow according to the change request.

For example, an area-specific environment management system described in Patent Document 3 includes a biological information sensor 10, an environment information sensor 20, a wakefulness estimation unit 30, and an environment provision unit 40. The wakefulness estimation unit 30 estimates, for example, a wakefulness of an individual, based on biological information detected by the biological information sensor 10. The environment provision unit 40 provides an environment of each area with an environment, based on the wakefulness and environmental information.

For example, an environment equipment control system according to Patent Document 4 is a system for bringing a wakefulness, which is a physical/mental state of a user, closer to a target wakefulness, by using a plurality of types of environment equipment. The environment equipment control system 1 mainly includes an air conditioning apparatus 10, an air ventilation apparatus 20, an aroma diffuser 30, a biological sensor 40, a remote controller 50, and an environment equipment control apparatus 100.

The biological sensor 40 described in Patent Document 4 is a sensor for recognizing a wakefulness of a user, and includes an electro cardiogram waveform sensor 41 that detects an electro cardiogram waveform of the user, and an expression camera 42 that detects an expression of a face of the user. The expression camera 42 is placed at a specific position in a room where an expression of a face of a user can be captured, and is capable of wirelessly transmitting detected expression data to a nearby device such as the environment equipment control apparatus 100. The environment equipment control apparatus 100 can acquire information from the biological sensor 40 and the remote controller 50, and control the air conditioning apparatus 10, the ventilation apparatus 20, and the aroma diffuser 30.

For example, a degree of wakefulness control system described in Patent Document 5 determines a degree of wakefulness of a subject of wakefulness control, controls a physical quantity in a surrounding environment of the subject of the degree of wakefulness control according to a determination result, and thereby maintains or improves the degree of wakefulness.

For example, an apparatus in a system described in Patent Document 6 is configured of three components: a detection unit 1, a determination unit 2, and a control unit 3. The detection unit 1 is for detecting an inner state of a room or a state of a person, and transmits information thereof to the determination unit 2. The determination unit 2 determines a state of a person, based on the information received from the detection unit 1. The control unit 3 includes an interface for controlling a device, and controls the device.

It is described that the detection unit 1 includes a plurality of cameras, a microphone, a temperature, and a humidity sensor as input devices, and is configured of an input control unit 11 that processes an input from the input apparatuses, detection function units 14, 15, 16, 17, and a result collection unit 13 that integrates results in various model databases 12 and compiles an output to the determination unit 2. As functions of the detection unit 1, a pose detection function, a face detection function, an eye-area observation function, and a mouth-area observation function are provided. The determination unit 2 determines, based on information received from the detection unit 1, how the device is to be controlled, and includes a control instruction function and the like.

For example, it is described in Patent Document 7 that a configuration may be employed in which clothing of a user is determined from a captured video, and temperature adjustment is instructed to air conditioners 10, 10A, and 10B, according to the clothing. For example, when it is confirmed that short-sleeved clothing is worn or a lap blanket is used while air-cooling is on, the air conditioner is instructed to turn down, and when long-sleeved clothing is worn, the air conditioner is instructed to turn up.

Note that, Patent Document 8 discloses a technique of computing a feature value of each of a plurality of key points of a human body included in an image, and based on the computed feature value, searching for an image including a human body in a similar pose or a human body in a similar motion, and grouping and classifying the similar poses and the similar motions. Non-Patent Document 1 discloses a technique related to human skeleton estimation.

### RELATED DOCUMENT

### Patent Document

Patent Document 1: Japanese Patent Application Publication No. 2013-213610
Patent Document 2: Japanese Patent Application Publication No. 2017-026230
Patent Document 3: International Patent Publication No. WO2018/179289
Patent Document 4: International Patent Publication No. WO2019/022079
Patent Document 5: International Patent Publication No. WO2020/162358
Patent Document 6: Japanese Patent Application Publication No. H8-257017
Patent Document 7: Japanese Patent Application Publication No. 2015-21666
Patent Document 8: International Patent Publication No. WO2021/084677

### Non-Patent Document

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, pp. 7291 to 7299

### DISCLOSURE OF THE INVENTION

### Technical Problem

In a technique described in Patent Documents 1 and 2, an air conditioner (air conditioner) is controlled based on a gesture. Herein, the gesture is a predetermined motion for controlling a device such as an air conditioner, and the same also applies to the following.

In the technique described in Patent Documents 1 and 2, for example, there is a risk that the air conditioner is controlled even when someone who is not suitable for controlling the air conditioner, such as a child, makes a gesture. Further, for example, it is possible that the air conditioner is controlled according to a gesture even when a guest who doesn't know how to operate the air conditioner using the gesture accidentally makes a motion being identical to the gesture. Therefore, as a result of unintentional control of the air conditioner, convenience for a user may be impaired, such as an atmospheric environment becomes uncomfortable.

Further, in the technique described in Patent Documents 1 and 2, for example, when a plurality of persons are in a room, each of the plurality of persons may operate the air conditioner using a gesture.

For example, it is possible that two persons make a gesture for lowering a target temperature by one degree at almost the same timing. In this case, as a result of controlling the air conditioner according to each gesture, it is possible that the air conditioner is controlled to lower the target temperature by two degrees. Specifically, when the plurality of persons make the same gesture, the air conditioner may be controlled excessively. Therefore, convenience of a user may be impaired, such as an atmospheric environment becomes uncomfortable.

Further, for example, it is possible that one of two persons makes a gesture for turning off air-cooling and the other one of the two persons makes a gesture for switching an operation mode from a cooling mode to an air-blowing mode at almost the same timing. In this case, it is unknown according to which gesture the operation mode of the air conditioner is set, and therefore it becomes difficult to control the air conditioner stably according to a gesture. Specifically, when each of the plurality of persons makes a gesture for an operation that differs from one another, it is possible to become difficult to control the air conditioner stably. Therefore, convenience for a user may be impaired.

In Patent Document 3 to 7, techniques for controlling an air conditioner and the like according to a motion of a person who does not intend to operate the air conditioner (air conditioning apparatus). In these techniques, as a result of controlling the air conditioner and the like while a person does not know, convenience for a user may be impaired, such as an atmospheric environment becomes uncomfortable.

One example of an object of the present invention, in view of the above-described problem, is to provide a control apparatus, a control system, a control method, and a program that solve a problem that convenience for a user may be impaired.

### Solution to Problem

According to one aspect of the present invention, a control apparatus is provided, including:
a detection unit that detects a predetermined first gesture by processing image information; and
a control unit that controls, when an input condition being a condition for allowing control of a device using the first gesture is satisfied, the device according to the first gesture.

According to one aspect of the present invention, a control system is provided, including:
the above-described control apparatus;
an imaging apparatus that generates the image information; and
the device.

According to one aspect of the present invention, a control method is provided, including,
by a computer:
detecting a predetermined first gesture by processing image information; and
controlling, when an input condition being a condition for allowing control of a device using the first gesture is satisfied, the device according to the first gesture.

According to one aspect of the present invention, a program for causing a computer to execute:
detecting a predetermined first gesture by processing image information; and
controlling, when an input condition being a condition for allowing control of a device using the first gesture is satisfied, the device according to the first gesture is provided.

### Advantageous Effects of Invention

According to the present invention, convenience for a user can be improved.

### BRIEF DESCRIPTION OF THE DRAWINGS

FIG. 1 is a diagram illustrating an outline of a control system according to a first example embodiment of the present invention.

FIG. 2 is a flowchart illustrating an outline of control processing according to the first example embodiment of the present invention.

FIG. 3 is a diagram illustrating a configuration example of the control system according to the first example embodiment of the present invention, together with a diagram illustrating one example of a subject space R in overhead view.

FIG. 4 is a diagram illustrating one example of gesture information according to the first example embodiment.

FIG. 5 is a diagram illustrating a physical configuration example of a control apparatus according to the first example embodiment of the present invention.

FIG. 6 is a flowchart illustrating one example of detection processing according to the first example embodiment.

FIG. 7 is a flowchart illustrating one example of device control processing according to the first example embodiment.

FIG. 8 is a diagram illustrating a configuration example of a control system according to a second example embodiment of the present invention, together with a diagram illustrating one example of a subject space R in overhead view.

FIG. 9 is a diagram illustrating one example of gesture information according to the second example embodiment.

FIG. 10 is a flowchart illustrating one example of detection processing according to the second example embodiment.

FIG. 11 is a diagram illustrating a configuration example of a control system according to a third example embodiment of the present invention, together with a diagram illustrating one example of a subject space R in overhead view.

FIG. 12 is a diagram illustrating one example of gesture information according to the third example embodiment.

FIG. 13 is a flowchart illustrating one example of detection processing according to the third example embodiment.

FIG. 14 is a diagram illustrating a configuration example of a control system according to a fourth example embodiment of the present invention, together with a diagram illustrating one example of a subject space R in overhead view.

FIG. 15 is a flowchart illustrating one example of detection processing according to the fourth example embodiment.

### EXAMPLE EMBODIMENT

In the following, example embodiments of the present invention are described with reference to the drawings. Note that, in all the drawings, a similar component is denoted with a similar reference sign, and description thereof is omitted as appropriate.

### First Example Embodiment

### (Outline)

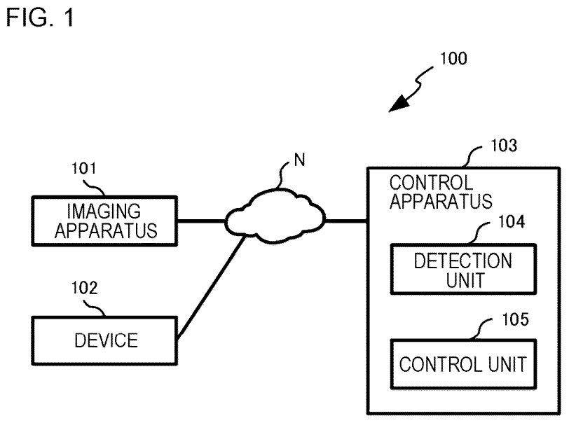

FIG. 1 is a diagram illustrating an outline of a control system 100 according to a first example embodiment of the present invention. The control system 100 includes an imaging apparatus 101, a device 102, and a control apparatus 103.

The imaging apparatus 101 generates image information.

The control apparatus 103 includes a detection unit 104 and a control unit 105.

The detection unit 104 detects a predetermined first gesture by processing image information.

The control unit 105 controls, when an input condition being a condition for allowing control of the device 102 using the first gesture is satisfied, the device 102 according to the first gesture.

According to the control system 100, convenience for a user can be improved. According to the control apparatus 103, convenience for a user can be improved.

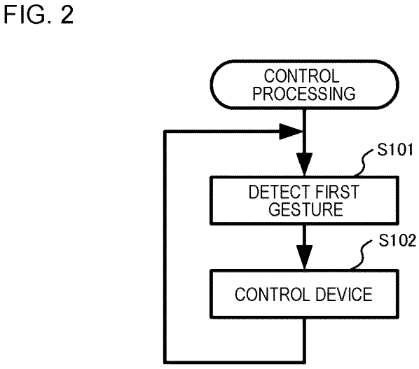

FIG. 2 is a flowchart illustrating an outline of control processing according to the first example embodiment of the present invention.

The detection unit 104 detects a predetermined first gesture by processing image information (step S101).

When an input condition being a condition for allowing control of the device 102 using the first gesture is satisfied, the control unit 105 controls the device 102 according to the first gesture (step S102).

According to this control processing, convenience for a user can be improved.

In the following, a detailed example of the control system 100 according to the first example embodiment is described.

### (Detailed Example)

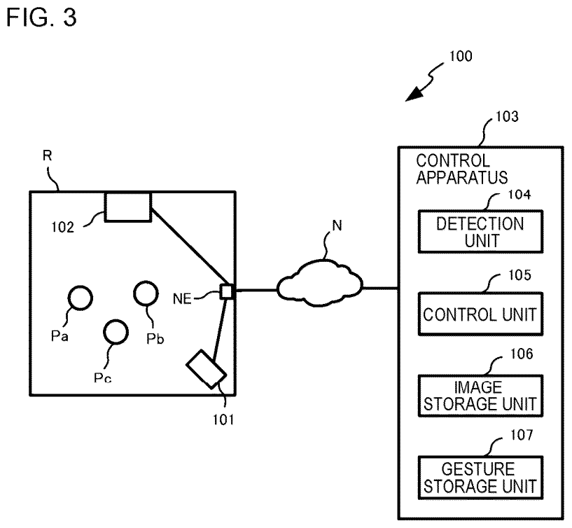

FIG. 3 is a diagram illustrating a configuration example of the control system 100 according to the first example embodiment of the present invention, together with a diagram illustrating one example of a subject space R in overhead view.

The control system 100 is a system for controlling the device 102 that operates in the subject space R, based on image information including an image capturing the subject space R. The control system 100 includes the imaging apparatus 101, the device 102, and the control apparatus 103.

The control apparatus 103 and each of the imaging apparatus 101 and the device 102 are connected via a network N. The network N is a communication network being configured wiredly, wirelessly, or by combining both. The control apparatus 103 and each of the imaging apparatus 101 and the device 102 transmit and receive information to and from each other, via the network N.

In the example illustrated in FIG. 3, the network N includes a node NE that relays between the control apparatus 103 and each of the imaging apparatus 101 and the device 102. Note that, in FIG. 3, a size ratio of the subject space R, the imaging apparatus 101, the device 102, and the like is changed as appropriate, in order to facilitate understanding of the figure.

### (Subject Space R)

The subject space R is a space in which the imaging apparatus 101 and the device 102 operate. The subject space R is a space being set, for example, to a part or the entirety of an inside or an outside of one or more buildings, structures, facilities, and the like. A size, a shape, and the like of the subject space R may vary.

One or more persons P enter and exit from the subject space R. FIG. 3 illustrates an example in which three persons Pa, Pb, Pc are in the subject space R. Specifically, each of the persons Pa, Pb, Pc according to the present example embodiment is an example of the person P enters and exits from the subject space R.

Note that, the subject space R may be plural. In this case, the control apparatus 103 may control the imaging apparatus 101 and device 102 in a similar way in each of the subject spaces R. Further, when there are a plurality of subject spaces R, each of the subject spaces R may be different in size, shape, and the like. There may be or may not be a space in between adjacent subject spaces R.

### (Imaging Apparatus 101)

The imaging apparatus 101 captures an image of the subject space R, and generates image information including the captured image. The imaging apparatus 101 is, for example, a camera such as an omnidirectional camera, a pan-tilt-zoom (PTZ) camera, and the like. The imaging apparatus 101 may be included in the apparatus 102, or may be included in another apparatus not being illustrated, or the like.

In more details, for example, the imaging apparatus 101 generates image information including an image capturing the subject space R, a capturing time, and an apparatus identifier (ID).

The capturing time is a time at which the imaging apparatus 101 captured the image. The imaging apparatus 101 keeps time and includes the capturing time in the image information.

The apparatus ID is information for identifying the imaging apparatus 101. For example, the apparatus ID may be given as appropriate, or may be an address of the imaging apparatus 101 in the network N. The imaging apparatus 101 preliminarily holds its own apparatus ID, and includes the apparatus ID in the image information.

The imaging apparatus 101 performs detection continuously and generates image information in real time. The imaging apparatus 101 continuously transmits the image information to the control apparatus 103 in real time.

Note that, the control system 100 may include a plurality of the imaging apparatuses 101. In this case, the plurality of imaging apparatuses 101 may capture an image of the subject space R. For example, in such a case in which the subject space R is a wide space, it is suitable that the plurality of the imaging apparatuses 101 are used for capturing an image of the subject space R.

### (Device 102)

The device 102 is a device that operates in the subject space R. The device 102 is a device that can be controlled by using control information transmitted from the control apparatus 103 via the network N.

Examples of the device 102 include an air conditioner (also referred to as an “air conditioner”), a lighting device, a television, a video recorder, a video player, a video recording/reproducing device, an audio device, a washing machine, a self-propelled vacuum cleaner, an air cleaner, and a cooking device such as a microwave oven. Note that, the device 102 includes an object referred to as an apparatus or equipment.

After acquiring the control information from the control apparatus 103, the device 102 operates according to the acquired control information.

The control information is information including an instruction for the device 102. The control information includes an instruction being relevant to a function provided to the device 102 that receives the control information. The instruction included in the control information includes, for example, one or a plurality of power on and power off (start and stop of operation), and various settings and changes. Examples of the various settings and changes include setting and changing an operation mode, a target temperature, an air volume, an air direction, brightness, a color tone, a channel, a timer, a sound volume, an intensity of vacuuming, cleaning, or the like. For example, in a case in which the device 102 is an air conditioner, the operation mode is a cooling mode, a heating mode, a dehumidification mode, and an air blowing mode.

Note that, the control system 100 may include a plurality of the devices 102. In this case, the plurality of devices 102 may operate in the subject space R. For example, when the device 102 is an air conditioner, a lighting device, or the like, and the subject space R is a wide space, it is suitable that a plurality of the devices 102 is used in order to operate in the subject space R.

### (Functional Configuration Example of Control Apparatus 103 According to First Example Embodiment)

FIG. 3 is referred again.

The control apparatus 103 controls the device 102 that operates in the subject space R, based on image information including an image capturing the subject space R.

The control apparatus 103 includes the detection unit 104, the control unit 105, an image storage unit 106, and a gesture storage unit 107.

The detection unit 104 acquires image information from the imaging apparatus 101. The detection unit 104 may continuously acquires the image information in real time. The detection unit 104 stores the acquired image information in the image storage unit 106.

The detection unit 104 detects a first gesture by processing the image information. The first gesture is a predetermined gesture. A gesture is one or a plurality of a motion of a body, a motion of a hand, a motion of a mouth, and the like that are a movement of a body, and a pose being a state of a body, and the like.

Further, the detection unit 104 according to the present example embodiment decides whether an input condition is satisfied, based on the image information.

As described above, the input condition is a condition for allowing control of the device 102 using the first gesture. The input condition includes one or a plurality of conditions provided with respect to the person P, a status of the subject space R, and the like.

The input condition includes a first condition. The first condition is a condition related to a feature value of an image (image feature value) of a person who makes the first gesture.

The first condition according to the present example embodiment is a condition related to a relation between an image feature value of a person who makes the first gesture and an image feature value of a predetermined authorized person. In more details, the first condition is that the image feature value (for example, a feature value of a face image) of the person who makes the first gesture matches the image feature value of the predetermined authorized person.

Herein, “match” includes not only complete match but also substantial match, specifically, includes a case in which the image feature values are different within a predetermined extent. The same also applies to the following.

Specifically, the detection unit 104 according to the present example embodiment decides, based on the image information, whether the image feature value of the person who makes the first gesture matches the image feature value of the predetermined authorized person. Then, according to a result of the decision, the detection unit 104 decides whether the input condition is satisfied.

Note that, the first condition is not limited to the condition related to a relation between the image feature value of the person who makes the first gesture and the image feature value of the predetermined authorized person. For example, the first condition may be a condition that a value indicating an overall body size that is one of human-body-related feature values (for example, a skeletal feature value) of the person who makes the first gesture is equal to or more than a predetermined value. For example, the first condition may be a condition that an age group as the image feature value of the person who makes the first gesture is equal to or older than a predetermined age group. According to these first conditions, for example, it is possible to restrict a child from controlling the device 102 using the first gesture.

Herein, an example of a method in which the detection unit 104 acquires an image feature value of a parson who makes the first gesture is described.

For example, the detection unit 104 detects the person P from an image. Further, the detection unit 104 includes at least one of a face recognition function, a human form recognition function, a pose recognition function, a motion recognition function, an external appearance attribute recognition function, a gradient feature detection function of an image, a color feature detection function of an image, an object recognition function, an age group estimation function, and the like.

The face recognition function extracts a face feature value being a feature value of a face image of the person P. The face recognition function may determine (estimate) a position of the person P in the subject space R by determining a position of a face of the person P in an image.

The human form recognition function extracts a human-body-related feature value of the person P. The human-body-related feature value is a value that indicates an overall feature such as fatness or thinness of a body shape, a height, clothing, and the like. The human-body-related feature value may include a skeletal feature value. The human form recognition function may determine (estimate) a position of the person P in the subject space R by determining a position of the person P in an image.

The pose recognition function and the motion recognition function detect a joint point of the person P, and generate a stick human model by connecting the joint points. By using the stick human model, the pose recognition function and the motion recognition function estimate a height of the person P, extract a feature value of a pose, and determine a motion, based on a change in pose. The pose recognition function and the motion recognition function may determine (estimate) a position of the person P in the subject space R by determining a position of the person P in an image. The pose recognition function and the motion recognition function may acquire a feature value of a pose and/or a feature value of a motion.

As an example of a technique applied to the pose recognition function and the motion recognition function, there exists a technique described in Patent Document 8 and Non-Patent Document 1.

The external appearance attribute recognition function recognizes an external appearance attribute (for example, a clothing color, a shoe color, a hairstyle, wearing a hat, a necktie, or the like, for example, there are more than 100 types of the external appearance attribute in total) being associated with the person P. The external appearance attribute recognition function may extract a feature value indicating an external appearance attribute (external appearance feature value).

The gradient feature detection function of an image outputs a feature value (a gradient feature value) using SIFT, SURF, RIFF, ORB, BRISK, CARD, HOG, and the like. The color feature detection function of an image outputs a feature value (a color feature value) indicating a color feature of the image, such as a color histogram.

The object recognition function detects an object from an image. The object recognition function may determine (estimate) a position of the person P in the subject space R by determining a position of the object in the image. As an example of a technique applied to the object recognition function, there exists YOLO (which is capable of extraction of a general object [for example, a car, a bicycle, a chair, and the like], and extraction of a person).

The age group estimation function estimates an age group to which the person P belongs, as an image feature value.

Each of the variety of feature values exemplified herein, which are the face feature value, the human-body-related feature value (for example, a skeletal feature value, and a value indicating an overall body size), the feature value of a pose (the pose feature value), the feature value of a motion (the motion feature value), the external appearance feature value, the gradient feature value, the color feature value, and an age group estimated from an image, is an example of the image feature value.

Such functions of the detection unit 104 can be achieved, for example, by using a learning model that has been learned using machine learning. The detection unit 104 uses, for example, a learning model for each of the functions. The learning model outputs a result being relevant to the function by using image information as an input. Input data to the learning model during learning are image information including an image of the person P. In the machine learning, supervised learning in which a result to be output for the image information is set as a correct answer may be performed.

For example, the detection unit 104 processes image information by using one or more of these functions and the like. Then, the detection unit 104 compares an image feature value acquired as a result of the processing, such as a motion feature value, a pose feature value, with a feature value of a motion, a state, and the like of a body being defined as the first gesture (specifically, an image feature value such as a motion feature value, a pose feature value, and the like). When a result of the comparison indicates that the image feature values match, the detection unit 104 detects a pose, a motion, and the like related to the image feature value, as the first gesture.

Note that, a method for acquiring an image feature value of a person who makes the first gesture is not limited to the method described herein. For example, various known techniques such as pattern matching can be used for acquiring an image feature value of a person who makes the first gesture.

The control unit 105 is a condition for allowing control of the device 102 using the first gesture. When an input condition is satisfied, the device 102 is controlled according to the first gesture. In more details, when deciding that the input condition is satisfied, the control unit 105 generates control information, according to the first gesture detected by the detection unit 104. The control unit 105 transmits the generated control information to the device 102.

The image storage unit 106 is a storage unit for storing image information.

The gesture storage unit 107 is a storage unit for storing gesture information 107a including the first gesture. In the gesture information 107a, the first gesture may be associated with a content of control of the device 102 to be performed in response to the first gesture.

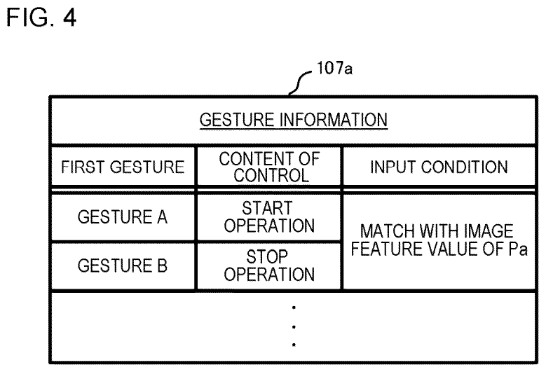

In the gesture information 107a according to the present example embodiment, as one example thereof illustrated in FIG. 4, the first gesture, a content of control, and an input condition are associated. The first gesture includes an image of a predetermined gesture or an image feature value of the image. The content of control includes a content of control of the device 102. The input condition according to the present example embodiment includes an image feature value of a predetermined authorized person.

The gesture information 107a illustrated in FIG. 4 includes, for example, data in which a first gesture “gesture A”, a content of control “start operation”, and an input condition “match with an image feature value of Pa” are associated with one another. The “gesture A” in the gesture information 107a may include an image feature value of the gesture A. The input condition in the gesture information 107a may also include the image feature value of Pa. Note that, “Pa” included in the gesture information 107a is information for identifying the person Pa, and indicates the person Pa.

This data indicate that, when the “gesture A” is detected from an image included in image information, the input condition is set that an image feature value of a person who makes the first gesture matches the image feature value of the person Pa. This data indicate that control of the device 102 using the “gesture A” as the first gesture is allowed when the input condition is satisfied. Specifically, in this data, the person Pa is set as the authorized person. Further, this data indicate that, when control of the device 102 using the “gesture A” is allowed, the device 102 is controlled to start operating.

According to such gesture information 107a, an input condition can be set for each first gesture. Therefore, convenience for a user can be improved.

Note that, in a case in which an input condition being common for all first gestures is used, the gesture information 107a may not include the input condition. In this case, the detection unit 104 may preliminarily hold the input condition.

The functional configuration of the control system 100 according to the present example embodiment has been mainly described so far. Hereinafter, a physical configuration of the control system 100 according to the present example embodiment is described.

### (Physical Configuration Example of Control System 100 According to First Example Embodiment)

The control system 100 is configured of the imaging apparatus 101, and the device 102 and the control apparatus 103 physically connected to each other via the network N.

Each of the imaging apparatus 101 and the device 102, according to the present example embodiment is physically configured as a separate unit. Note that, the imaging apparatus 101 and the device 102 may be physically configured as a single unit.

The control apparatus 103 according to the present example embodiment is physically configured of a single apparatus. Note that, the control apparatus 103 may physically be configured of a plurality of apparatuses connected to each other via an appropriate communication line such as the network N. One example of physically configuring the control apparatus 103 with a plurality of apparatuses includes configuring the control apparatus 103 by physically dividing the control apparatus 103 into an apparatus provided with the function of the detection unit 104 and an apparatus provided with a function of another unit such as the control unit 105. Each of the apparatuses in this case is a general-purpose computer, a tablet terminal, a portable terminal, and the like.

### (Physical Configuration Example of Control Apparatus 103 According to First Example Embodiment)

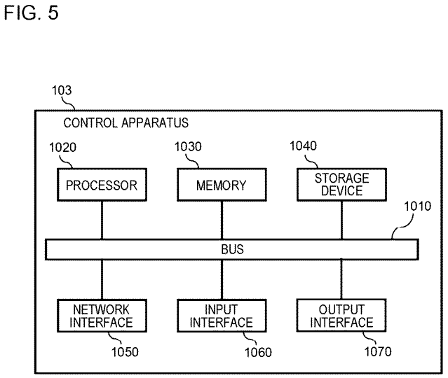

For example, the control apparatus 103 is physically a general-purpose computer and the like. The control apparatus 103 may be a tablet terminal, a portable terminal, and the like. In more details, for example, as illustrated in FIG. 5, the control apparatus 103 physically includes a bus 1010, a processor 1020, a memory 1030, a storage device 1040, a network interface 1050, an input interface 1060, and an output interface 1070.

The bus 1010 is a data transmission path for the processor 1020, the memory 1030, the storage device 1040, the network interface 1050, the input interface 1060, and the output interface 1070 to mutually transmit and receive data. Note that, a method for connecting the processor 1020 and the like to one another is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module for achieving the function of the control apparatus 103. The processor 1020 reads each of the program modules on the memory 1030 and executes the program module, and thereby achieves a function related to the program module.

The network interface 1050 is an interface for connecting the control apparatus 103 to the network N.

The input interface 1060 is an interface for a user to input information. The input interface 1060 is, for example, configured of one or a plurality of a touch panel, a keyboard, a mouse, and the like.

The output interface 1070 is an interface for providing a user with information. The output interface 1070 is configured of one or a plurality of a liquid crystal panel, an organic electro-luminescence (EL) panel, and the like.

The physical configuration of the control system 100 according to the present example embodiment has been described so far. Hereinafter, an operation of the control system 100 according to the present example embodiment is described.

### (Operation of Control System 100 According to First Example Embodiment)

The control apparatus 103 executes control processing illustrated in FIG. 2. The control processing is processing for controlling the device 102 that operates in the subject space R, based on image information including an image capturing the subject space R.

For example, when receiving a start instruction from a user, the control apparatus 103 repeatedly executes the control processing (see FIG. 2), until receiving an end instruction from a user.

The gesture storage unit 107 preliminarily stores the gesture information 107a. In the following, description is made with reference to an example in which the gesture information 107a illustrated in FIG. 4 is stored in the gesture storage unit 107, as appropriate.

Referring to FIG. 2, the detection unit 104 detects the first gesture by processing image information (step S101).

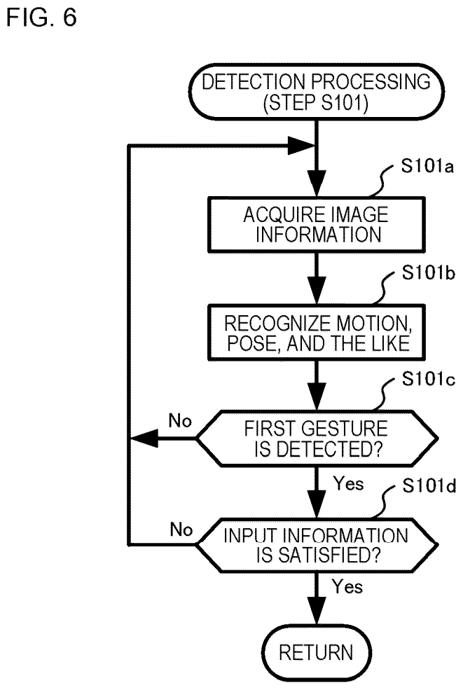

FIG. 6 is a flowchart illustrating one example of the detection processing (step S101).

The detection unit 104 acquires image information from the imaging apparatus 101 (step S101a). The detection unit 104 stores the acquired image information in the image storage unit 106.

The detection unit 104 recognizes a motion, a pose, and the like of the person P by processing the image information (step S101b).

More specifically, the detection unit 104 recognizes a motion, a pose, and the like of the person P included in the image information, by using one or a plurality of the face recognition function, the human form recognition function, the pose recognition function, the motion recognition function, the external appearance attribute recognition function, the gradient feature detection function of an image, the color feature detection function of an image, the object recognition function, the age group estimation function, and the like.

The detection unit 104 decides whether the first gesture is detected (step S101c).

In more details, when a motion, a pose, and the like of the person P of which, for example, the image feature value matches that of the first gesture included in the gesture information 107a is recognized in step S101b, the detection unit 104 decides that the first gesture is detected. When a motion, a pose, and the like of the person P of which, for example, the image feature value matches that of the first gesture included in the gesture information 107a is not recognized in step S101b, the detection unit 104 decides that the first gesture is not detected.

For example, when a motion of the person Pa of which the image feature value matches that of the “gesture A” is recognized from the image in step S101b, the detection unit 104 decides that the first gesture “gesture A” is detected. For example, when a motion of the person Pb of which the image feature value matches that of the “gesture A” is recognized from the image in step S101b, the detection unit 104 also decides that the first gesture “gesture A” is detected.

For example, when a motion, a pose, and the like of the persons Pa to Pc of which the image feature value matches that of any of the first gestures included in the gesture information 107a is not recognized in step S101b, the detection unit 104 decides that the first gesture is not detected.

When deciding that the first gesture is not detected (step S101c; No), the detection unit 104 executes step S101a again.

When deciding that the first gesture is detected (step S101c; Yes), the detection unit 104 decides whether the input condition is satisfied (step S101d).

In more details, the detection unit 104 acquires an image feature value of a person who makes the first gesture, based on the image including the first gesture detected in step S101c. Further, the detection unit 104 refers to the gesture information 107a, and acquires the input condition associated with the detected first gesture. In the present example embodiment, the input condition acquired herein is a match with an image feature value of an authorized person. Further, the input condition acquired herein also includes the image feature value of the authorized person.

Thus, the detection unit 104 compares the image feature value of the person who makes the first gesture with the image feature value of the authorized person included in the input condition. According to s result of the comparison, the detection unit 104 decides whether the input condition is satisfied. In more details, when the compared image feature values match, the detection unit 104 decides that the input condition is satisfied. When the compared image feature values do not match, the detection unit 104 decides that the input condition is not satisfied.

For example, when the “gesture A” is detected in step S101c, referring to the gesture information 107a, the input condition associated with the “gesture A” is a match with the image feature value of the person Pa (the authorized person).

When a person who makes the “gesture A” is the person Pa, the image feature value of the person who makes the “gesture A” matches the image feature value of the authorized person. In this case, the detection unit 104 decides that the input condition is satisfied. Meanwhile, when the person who makes the “gesture A” is the person Pb, the image feature value of the person who makes the “gesture A” does not match the image feature value of the authorized person. In this case, the detection unit 104 determines that the input condition is not satisfied.

When deciding that the input condition is not satisfied (step S101d; No), the detection unit 104 executes step S101a again.

When deciding that the input condition is satisfied (step S101d; Yes), the detection unit 104 returns to the control processing (see FIG. 2).

Referring to FIG. 2, the control unit 105 controls the device 102 as a subject device, according to the first gesture detected in step S101 (step S102).

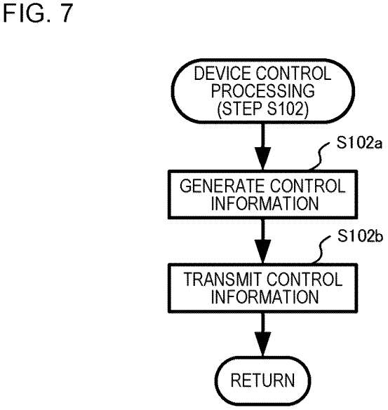

FIG. 7 is a flowchart illustrating one example of device control processing (step S102).

The control unit 105 generates control information according to the first gesture detected in step S101 (step S102a).

In more details, the control unit 105 acquires, based on the gesture information 107a, a content of control associated with the first gesture detected in step S101. The control unit 105 generates control information including, as an instruction, the acquired content of control.

For example, when the “gesture A” is detected as the first gesture in step S101, referring to the gesture information 107a, a content of control associated with the “gesture A” is “start operation”. Therefore, the control unit 105 generates control information including an instruction to start operation.

The control unit 105 transmits the generated control information to the device 102 (step S102a), and returns to step S101.

As a result of step S102a being executed, the device 102 acquires the control information. The device 102 operates according to the control information. For example, when acquiring the control information including the instruction to start operation, the device 102 starts operating, according to the control information. By executing such control processing, the device 102 that operates in the subject space R can be controlled based on image information including an image capturing the subject space R.

The first example embodiment of the present invention has been described so far.

According to the present example embodiment, the control apparatus 103 includes the detection unit 104 and the control unit 105. The detection unit 104 detects a predetermined first gesture by processing image information. When an input condition being a condition for allowing control of the device 102 using the first gesture is satisfied, the control unit 105 controls the device 102 according to the first gesture.

Thereby, the device 102 can be controlled using the first gesture being a predetermined gesture. Further, since the input condition is used, a person who is capable of controlling the device 102 by using the first gesture can be limited, and a possibility that the device 102 is controlled in such a way that may impair convenience for a user can be reduced. Therefore, convenience for a user can be improved.

According to the present example embodiment, the detection unit 104 further decides whether an input condition is satisfied, based on image information. Therefore, there is no need for the detection unit 104 to acquire information other than the image information in order to decide whether the input condition is satisfied, and a trouble for a user of inputting another piece of information can be saved. Therefore, convenience for a user can be improved.

According to the present example embodiment, an input condition includes a condition related to an image feature value of a person who makes a first gesture. Thereby, a person who is capable of controlling the device 102 by using the first gesture can be limited, and a possibility that the device 102 is controlled in such a way that may impair convenience for a user can be reduced. Therefore, convenience for a user can be improved.

According to the present example embodiment, an input condition includes a condition related to a relation between an image feature value of a person who makes a first gesture and an image feature value of a predetermined authorized person. Thereby, a person who is capable of controlling the device 102 by using the first gesture can be limited to the authorized person, and a possibility that the device 102 is controlled in such a way that may impair convenience for a user can be reduced. Therefore, convenience for a user can be improved.

### Second Example Embodiment

In the present example embodiment, an example in which a predetermined second gesture is used as a trigger for controlling a device 102 using a first gesture. In the present example embodiment, for simplicity of description, description redundant to that in the first example embodiment is omitted as appropriate.

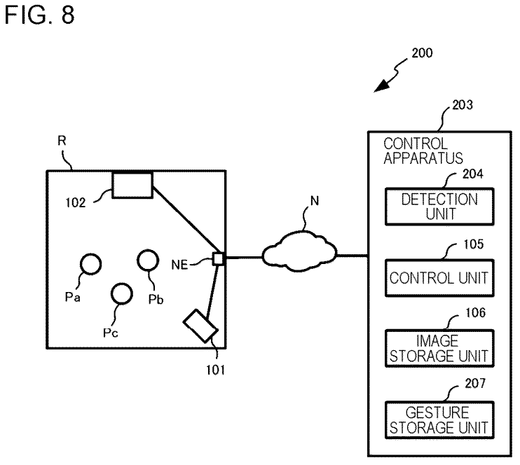

FIG. 8 is a diagram illustrating a configuration example of a control system 200 according to a second example embodiment of the present invention, together with a diagram illustrating one example of a subject space R in overhead view.

The control system 200 according to the present example embodiment includes an imaging apparatus 101 and the device 102 similar to those in the first example embodiment, and a control apparatus 203 in place of the control apparatus 103 according to the first example embodiment.

### (Functional Configuration Example of Control Apparatus 203 According to Second Example Embodiment)

The control apparatus 203 includes a detection unit 204 in place of the detection unit 104 according to the first example embodiment, and a gesture storage unit 207 in place of the gesture storage unit 107 according to the first example embodiment. Except for these, the control apparatus 203 may similarly be configured as the control apparatus 103 according to the first example embodiment (see FIG. 3).

The detection unit 204 detects a predetermined second gesture by processing image information.

A method for detecting the second gesture may be similar to the method for detecting the first gesture described in the first example embodiment.

Specifically, the detection unit 204 processes the image information by using one or more of a face recognition function, a human form recognition function, a pose recognition function, a motion recognition function, an external appearance attribute recognition function, a gradient feature detection function of an image, a color feature detection function of an image, an object recognition function, an age group estimation function, and the like. Then, the detection unit 204 compares an image feature value such as a pose feature value, a motion feature value, and the like acquired as a result of the processing with a feature value of a motion of a body, a state of a body, and the like defined as the second gesture (specifically, an image feature value such as a motion feature value, a pose feature value, and the like). When a result of the comparison indicates that the image feature values match, the detection unit 204 detects a pose, a motion, and the like related to the image feature value, as the second gesture.

As in the first example embodiment, the detection unit 204 decides whether an input condition for allowing control of the device 102 using the first gesture is satisfied, based on the image information. In the present example embodiment, a condition included in the input condition is different from that in the first example embodiment.

The input condition according to the present example embodiment includes a second condition. The second condition is a condition related to a relation between an image feature value of a person who makes the first gesture and an image feature value of a person who makes the second gesture. The image feature value is one or a plurality of a face feature value, a human-body-related feature value (for example, a skeletal feature value), and the like.

The second condition according to the present example embodiment is that the image feature value of the person who makes the first gesture and the image feature value of the person who makes the second gesture match.

As in the first example embodiment, the detection unit 204 detects the first gesture by processing image information. The detection unit 204 according to the present example embodiment detects the first gesture, in a case in which the detection unit 204 has detected the second gesture, based on image information being acquired after the second gesture is detected.

Except for these, the detection unit 204 may similarly be configured as the detection unit 104 according to the example embodiment 1.

As in the first example embodiment, the gesture storage unit 207 is a storage unit for storing gesture information 207a including the first gesture. In the gesture information 207a, the first gesture may be associated with a content of control of the device 102 to be performed in response to the first gesture, and the second gesture may be associated with the first gesture and the content of control.

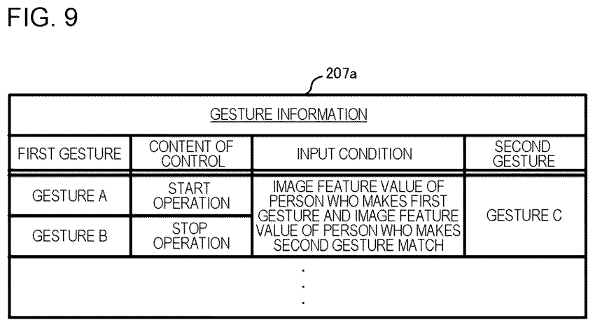

In the gesture information 207a according to the present example embodiment, as one example thereof illustrated in FIG. 9, a first gesture, a content of control, an input condition, and a second gesture are associated with one another. As described above, the input condition according to the present example embodiment is different from that in the first example embodiment. The second gesture includes a gesture being different from the first gesture or an image feature value of the gesture. Except for these, the gesture information 207a may similarly be configured as the gesture information 107a according to the first example embodiment.

The gesture information 207a illustrated in FIG. 9 includes, for example, data in which a first gesture “gesture A”, a content of control “start operation”, an input condition “an image feature value of the first gesture and an image feature value of the second gesture match”, and a second gesture “gesture C” are associated with one another. The second gesture in the gesture information 207a may include an image feature value of the gesture C.

This data indicate that the second gesture is the “gesture C”. This data indicate that, when the “gesture C” and the “gesture A” are detected from an image included in the image information, the input condition is that the image feature value of the first gesture and the image feature value of the second gesture match. This data indicate that control of the device 102 using the “gesture A” as the first gesture is allowed when the input condition is satisfied. This data indicate that, when the control of the device 102 using the “gesture A” is allowed, the device 102 is controlled to start operating.

According to such gesture information 207a, a second gesture can be set for each first gesture. Therefore, convenience for a user can be improved.

Note that, in a case in which a second gesture being common for all first gestures is used, the gesture information 207a may not include the second gesture. In this case, the detection unit 204 may preliminarily hold the second gesture.

The functional configuration of the control system 200 according to the present example embodiment has been mainly described so far. Physically, the control system 200 according to the present example embodiment may similarly be configured as the control system 100 according to the first example embodiment. Hereinafter, an operation of the control system 200 according to the present example embodiment is described.

### (Operation of Control System 200 According to Second Example Embodiment)

The control apparatus 203 executes detection processing (step S201) in place of the detection processing (step S101) in the control processing illustrated in FIG. 2. Except for this point, control processing according to the present example embodiment may be similar to the control processing according to the first example embodiment.

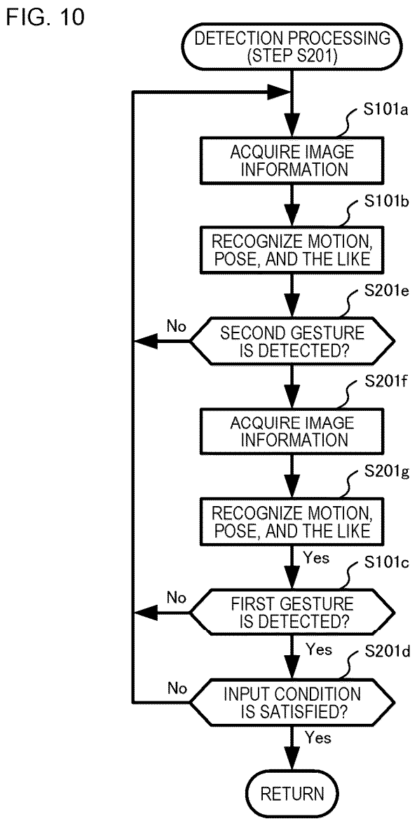

FIG. 10 is a flowchart illustrating one example of the detection processing (step S201).

As illustrated in FIG. 10, the detection processing (step S201) further includes steps S201e to S201g to be executed between steps S101b and S101c similar to those in the first example embodiment. Further, the detection processing (step S201) includes step S201d in place of step S101d according to the first example embodiment. Except for these, the control processing according to the present example embodiment may be similar to the control processing according to the first example embodiment.

In the following, description is made with reference to an example in which the gesture information 207a illustrated in FIG. 9 is preliminarily stored in the gesture storage unit 207, as appropriate.

In step S201e, the detection unit 204 determines whether the second gesture is detected.

In more details, when a motion, a pose, and the like of a person P of which, for example, the image feature value matches that of the second gesture included in the gesture information 207a is recognized in step S101b, the detection unit 204 decides that the second gesture is detected. When a motion, a pose, and the like of the person P of which, for example, the image feature value matches that of the second gesture included in the gesture information 207a is not recognized in step S101b, the detection unit 204 decides that the second gesture is not detected.

For example, referring to the gesture information 207a in FIG. 9, when a motion of a person Pa of which the image feature value matches that of the “gesture C” is recognized from an image in step S101b, the detection unit 204 decides that the second gesture “gesture C” is detected. For example, when a motion of a person Pb of which the image feature value matches that of the “gesture C” is recognized from an image in step S101b, the detection unit 204 decides that the second gesture “gesture C” is detected.

For example, a motion, a pose, and the like of the persons Pa to Pc of which the image feature value matches that of the second gesture included in the gesture information 207a is not recognized in step S101b, the detection unit 204 decides that the second gesture is not detected.

When deciding that the second gesture is not detected (step S201e; No), the detection unit 204 executes step S101a again.

When deciding that the second gesture is detected (step S201e; Yes), the detection unit 204 executes steps S201e to S201f similar to steps S101a to S101b. Then, the detection unit 204 executes step S101c similar to that in the first example embodiment.

However, in step S101c according to the present example embodiment, whether the first gesture is detected is decided based on an image feature value, such as a motion feature value and a pose feature value, of the person P recognized in step S101f. Therefore, the first gesture can be detected based on image information being acquired after the second gesture is detected. Further, in step S101c according to the present example embodiment, the detection unit 204 may decide that the first gesture is not detected when the first gesture is not detected within a predetermined time.

When the second gesture is detected (step S201; Yes), the detection unit 204 subsequently executes steps S201e to S201f, and executes step S101c. Therefore, the detection unit 204 can detect the first gesture by processing image information being acquired after the second gesture is detected.

When deciding that the first gesture is detected (step S101c; Yes), the detection unit 204 decides whether an input condition is satisfied (step S201d).

In more details, the detection unit 204 acquires an image feature value of a person who makes the first gesture, based on the image including the first gesture detected in step S101c. Further, the detection unit 204 acquires, an image feature value of a person who makes the second gesture, based on the image including the second gesture detected in step S201e.

Further, the detection unit 204 refers to the gesture information 207a, and acquires an input condition associated with the detected first gesture. As described above, in the present example embodiment, the input condition acquired herein is that the image feature value of the person who makes the first gesture and the image feature value of the person who makes the second gesture match.

Therefore, the detection unit 204 compares the image feature value of the person who makes the first gesture with the image feature value of the person who makes the second gesture. The detection unit 204 decides whether the input condition is satisfied, according to a result of the comparison. In more details, when the compared image feature values match, the detection unit 204 decides that the input condition is satisfied. When the compared image feature values do not match, the detection unit 204 decides that the input condition is not satisfied.

For example, referring to the gesture information 207a in FIG. 9, it is assumed that a person who makes a “gesture A” being the first gesture detected in step S101c is the person Pa. In this case, when a person who makes the “gesture C” being the second gesture detected in step S201e is the person Pa, the image feature value of the person who makes the first gesture and the image feature value of the person who makes the second gesture match. Therefore, in this occasion, the detection unit 204 decides that the input condition is satisfied. Meanwhile, when the person who makes the “gesture A” is the person Pb, the image feature value of the person who makes the first gesture and the image feature value of the person who makes the second gesture do not match. Therefore, in this occasion, the detection unit 204 decides that the input condition is not satisfied.

When deciding that the input condition is not satisfied (step S201d; No), the detection unit 204 executes step S101a again.

When deciding that the input condition is satisfied (step S201d; Yes), the detection unit 204 returns to the control processing (see FIG. 2).

Then, the control unit 105 executes device control processing (step S102) similar to that in the first example embodiment. By executing such control processing, the device 102 can be controlled using the first gesture while using the second gesture as a trigger.

The second example embodiment of the present invention has been described so far.

According to the present example embodiment, the detection unit 204 detects a predetermined second gesture by processing image information. Further, an input condition includes a condition related to a relation between an image feature value of a person who makes the first gesture and an image feature value of the person who makes the second gesture.

Thereby, the device 102 can be controlled by using the first gesture being a predetermined gesture. Further, since the input condition is used, a person who is capable of controlling the device 102 by using the first gesture can be limited to the person who makes the second gesture, and a possibility that the device 102 is controlled in such a way that may impair convenience for a user can be reduced. Thus, convenience for a user can be improved.

Further, unlike the first example embodiment, there is no need to preliminarily set an image feature value of an authorized person in the gesture information 207a. Therefore, a trouble for a user of setting preliminarily can be reduced. Therefore, convenience for a user can be improved.

According to the present example embodiment, the detection unit 204 detects a first gesture, in a case in which the detection unit 204 has detected a second gesture, based on image information being acquired after the second gesture is detected. Thereby, the first gesture can be detected from an image being acquired after the second gesture is detected, and the second gesture can be used as a trigger for controlling the device 102 using the first gesture.

Consequently, a time period when the device 102 can be controlled by using the first gesture can be limited to after the second gesture is detected, and therefore a possibility that the device 102 is controlled by a motion with no intention of controlling the device 102 can be reduced. Specifically, a possibility that the device 102 is controlled in such a way that may impair convenience for a user can be reduced. Therefore, convenience for a user can be improved.

### Third Example Embodiment

In the present example embodiment, an example in which trigger voice being a predetermined voice is used as a trigger for controlling a device 102 using a first gesture is described. In the present example embodiment, for simplicity of description, description redundant to that in the first example embodiment is omitted as appropriate.

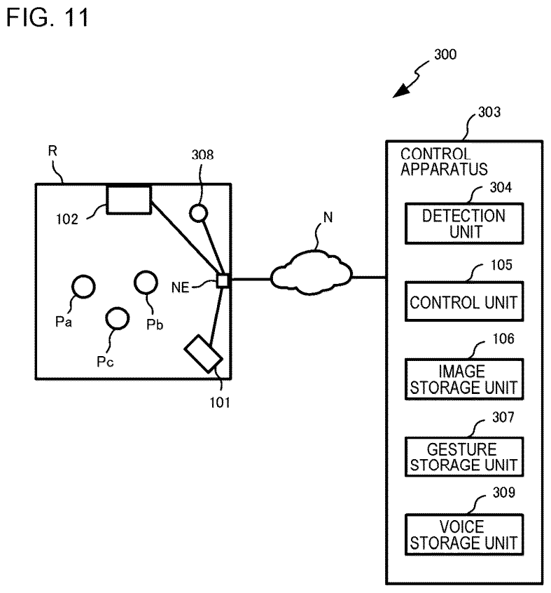

FIG. 11 is a diagram illustrating a configuration example of a control system 300 according to a third example embodiment of the present invention, together with a diagram illustrating one example of a subject space R in overhead view.

The control system 300 according to the present example embodiment includes an imaging apparatus 101 and the device 102 similar to those in the first example embodiment, and a control apparatus 303 in place of the control apparatus 103 according to the first example embodiment. The control system 300 further includes a voice detection apparatus 308.

### (Voice Detection Apparatus 308)

The voice detection apparatus 308 detects sound in subject space R, and generates sound information including the detected sound. The voice detection apparatus 308 is, for example, a microphone. The voice detection apparatus 308 may be included in the imaging apparatus 101, the device 102, another apparatus not being illustrated, or the like.

In more details, for example, the voice detection apparatus 308 generates voice information including sound detected in the subject space R, a time of detection, and a detection apparatus ID.

The time of detection is a time at which the voice detection apparatus 308 detects the sound. The voice detection apparatus 308 keeps time, and includes the time of detection in image information.

The detection apparatus ID is information for identifying the voice detection apparatus 308. For example, the detection apparatus ID may be, given as appropriate, or may be an address of the voice detection apparatus 308 in a network N. The voice detection apparatus 308 preliminarily holds its own detection apparatus ID, and includes the detection apparatus ID in the image information.

The voice detection apparatus 308 performs detection continuously, and generates voice information in real time. The imaging apparatus 101 continuously transmits the image information to the control apparatus 103 in real time.

Note that, the control system 300 may include a plurality of the voice detection apparatuses 308. In this case, the plurality of voice detection apparatuses 308 may detect voice in the subject space R. For example, in such a case in which the subject space R is a wide space, it is suitable that the plurality of voice detection apparatuses 308 are used for detecting voice in the subject space R.

### (Functional Configuration Example of Control Apparatus 303 According to Third Example Embodiment)

The control apparatus 303 includes a detection unit 304 in place of the detection unit 104 according to the first example embodiment, and a gesture storage unit 307 in place of the gesture storage unit 107 according to the first example embodiment. The control apparatus 303 further includes a voice storage unit 309. Except for these, the control apparatus 303 may similarly be configured as the control apparatus 103 according to the first example embodiment (see FIG. 3).

The detection unit 304 acquires voice information from the voice detection apparatus 308. The detection unit 304 may continuously acquire voice information in real time. The detection unit 304 stores the acquired voice information in the voice storage unit 309.

The detection unit 304 detects a voice trigger by processing the voice information. The voice trigger is a predetermined voice.

Further, as in the first example embodiment, the detection unit 304 according to the present example embodiment decides whether an input condition for allowing control of the device 102 using the first gesture is satisfied. In the present example embodiment, the detection unit 304 decides whether the input condition is satisfied, based on the voice information. Further, in the present example embodiment, a condition included in the input condition is different from that in the first example embodiment.

The input condition according to the present example embodiment includes a third condition. The third condition is that a predetermined trigger voice is detected from the voice information.

The input condition according to the present example embodiment further includes a fourth condition. The fourth condition is a condition related to a feature value of voice (a voice feature value) of a person who utters the trigger voice.

The fourth condition according to the present example embodiment is a condition related to a relation between the voice feature value of a person object who utters the trigger voice and a voice feature value of a predetermined authorized person. In more details, the fourth condition is that the voice feature value of the person who utters the trigger voice and the voice feature value of the predetermined authorized person match.

Specifically, the detection unit 304 according to the present example embodiment decides whether the voice feature value of the person who utters the trigger voice and the voice feature value of the predetermined authorized person match, based on the voice information. Then, the detection unit 304 decides whether the input condition is satisfied, based on a result of the decision.

Note that, the fourth condition is not limited to a condition related to a relation between the voice feature value of the person who utters the trigger voice and the voice feature value of the predetermined authorized person. For example, the fourth condition may be a condition that an age group as the voice feature value of the person who utters the trigger voice is equal to or older than a predetermined age group. According to the fourth condition, for example, it is possible to restrict a child from controlling the device 102 using the first gesture.

Herein, the detection unit 304 describes an example of a method for acquiring a voice feature value of a person who utters trigger voice.

For example, the detection unit 304 includes at least one of an acoustic feature value extraction function, an age group estimation function, and the like. The acoustic feature value extraction function extracts an acoustic feature value of voice (for example, a spectrum, a fundamental frequency, and a cepstrum). The age group estimation function estimates an age group to which a person P belongs, as a voice feature value.

Each of the variety of feature values exemplified herein, which are the acoustic feature value and the age group estimated from voice, is an example of the voice feature value.

Such a functions of the detection unit 304 can be achieved, for example, by using a learning model that has been learned using machine learning. The detection unit 304 uses, for example, a learning model for each of the functions. The learning model outputs a result being relevant to the function by using voice information as an input. Input data to the learning model during learning are voice information including voice of the person P. In the machine learning, supervised learning in which a result to be output for the voice information is set as a correct answer may be performed.

Note that, a method for acquiring the voice feature value of a person who utters the trigger voice is not limited to the method described herein. For example, various known techniques of an acoustic analysis and the like can be used for acquiring a voice feature value of a person who utters the trigger voice.

For example, the detection unit 304 processes voice information by using one or more of these functions and the like. Then, the detection unit 304 compares a voice feature value acquired as a result of the processing with a voice feature value of voice being defined as the trigger voice. When a result of the comparison indicates that the voice feature values match, the detection unit 104 detects voice related to the voice feature value, as the trigger voice.

As in the first example embodiment, the detection unit 304 detects the first gesture by processing image information. The detection unit 304 according to the present example embodiment detects the first gesture, in a case in which the trigger voice is detected from the voice information, by processing image information acquired after the trigger voice is detected.

Except for these, the detection unit 304 may similarly be configured as the detection unit 104 according to the first example embodiment.

As in the first example embodiment, the gesture storage unit 307 is a storage unit for storing gesture information 307a including the first gesture. In the gesture information 307a, the first gesture may be associated with a content of control of the device 102 to be performed in response to the first gesture, and the trigger voice may be associated with the first gesture and the content of control.

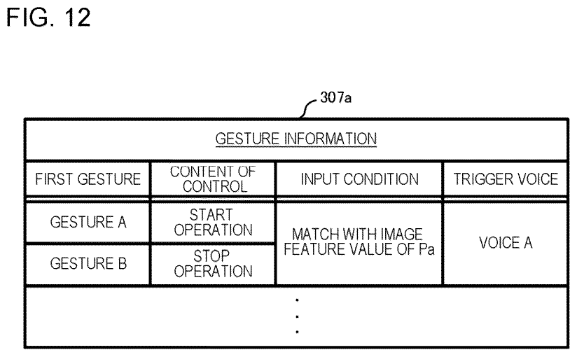

In the gesture information 307a according to the present example embodiment, as one example thereof illustrated in FIG. 12, a first gesture, a content of control, an input condition, and trigger voice are associated with one another. As described above, the input condition according to the present example embodiment is different from that in the first example embodiment, and includes the voice feature value of the predetermined authorized person. The trigger voice includes predetermined voice or a voice feature value of the voice. Except for these, the gesture information 307a may similarly be configured as the gesture information 107a according to the first example embodiment.

The gesture information 307a illustrated in FIG. 12 includes, for example, data in which a first gesture “gesture A”, a content of control “start operation”, an input condition “match with a voice feature value of Pa”, and trigger voice “voice A” are associated with one another. The trigger voice in the gesture information 307a may include a voice feature value of the voice A. Note that, as in the gesture information 107a, “Pa” included in the gesture information 307a is information for identifying a person Pa, and indicates the person Pa.

This data indicate that the trigger voice is the “voice A”. This data indicate that the input condition is that, when the “voice A” is detected from voices included in voice information and the “gesture A” is detected from an image included in image information, a voice feature value of a person who utters the trigger voice matches with a voice feature value of the person Pa. This data indicate that control of the device 102 using the “gesture A” as the first gesture is allowed when the input condition is satisfied. This data indicate that, when the control of the device 102 using the “gesture A” is allowed, the device 102 is controlled to start operating.

According to such gesture information 307a, trigger voice can be set for each first gesture. Therefore, convenience for a user can be improved.

Note that, in a case in which trigger voice being common for all first gestures is used, the gesture information 207a may not include the trigger voice. In this case, the detection unit 304 may preliminarily hold the trigger voice.

The voice storage unit 309 is a storage unit for storing the voice information.

The functional configuration of the control system 300 according to the present example embodiment has been mainly described so far. Physically, the control system 300 according to the present example embodiment may similarly be configured as the control system 100 according to the first example embodiment with addition of a microphone configuring the voice detection apparatus 308. Hereinafter, an operation of the control system 300 according to the present example embodiment is described.

### (Operation of Control System 300 According to Third Example Embodiment)

The control apparatus 303 executes detection processing (step S301) in place of the detection processing (step S101) in the control processing illustrated in FIG. 2. Except for this point, control processing according to the present example embodiment may be similar to the control processing according to the first example embodiment.

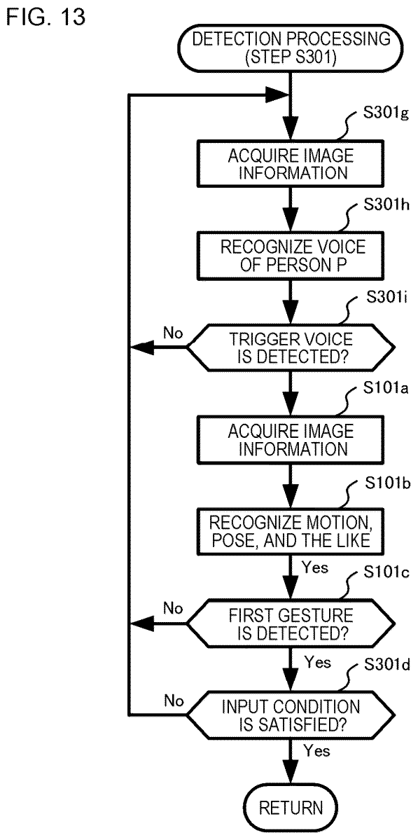

FIG. 13 is a flowchart illustrating one example of the detection processing (step S301).

As illustrated in FIG. 13, the detection processing (step S301) further includes steps S301g to S301i to be executed before step S101a similar to that in the first example embodiment. Further, the detection processing (step S301) includes step S301d in place of step S101d according to the first example embodiment. Except for these, the control processing according to the present example embodiment may be similar to the control processing according to the first example embodiment.

In the following, description is made with reference to an example in which the gesture information 307a illustrated in FIG. 12 is preliminarily stored in the gesture storage unit 307, as appropriate.

The detection unit 304 acquires voice information from the voice detection apparatus 308 (step S301g). The detection unit 304 stores the acquired voice information in the voice storage unit 309.

The detection unit 304 recognizes voice of the person P by processing the voice information (step S301h).

In more details, the detection unit 304 recognizes the voice of the person P included in the voice information by using one or a plurality of the acoustic feature value extraction function, the age group estimation function, and the like.

The detection unit 304 decides whether trigger voice is detected (step S301i).

In more details, when voice of the person P of which, for example, the voice feature value matches that of the trigger voice included in the gesture information 307a is recognized in step S301h, the detection unit 304 decides that the trigger voice is detected. When voice of the person P of which, for example, the voice feature value matches that of the trigger voice included in the gesture information 307a is not recognized in step S301h, the detection unit 304 decides that the trigger voice is not detected.

For example, when voice of the person Pa of which the voice feature value matches that of the “voice A” is recognized in step S301h from voices included in the voice information, the detection unit 304 decides that the trigger voice “voice A” is detected. For example, when voice of a person Pb of which the voice feature value matches that of the “voice A” is recognized in step S301h from the voices included in the voice information, detection unit 304 also decides that the trigger voice “voice A” is detected.

For example, when voice of the persons Pa to Pc of which the voice feature value matches that of the trigger voice included in the gesture information 307a is not recognized in step S101b, the detection unit 304 decides that the trigger voice is not detected.

When deciding that he trigger voice is not detected (step S301i; No), the detection unit 304 executes step S301g again.

When deciding that the trigger voice is detected (step S301i; Yes), the detection unit 304 executes steps S101a to S101c similar to those in the first example embodiment.

However, in the present example embodiment, when deciding that the first gesture is not detected (step S101c; No) the detection unit 304 executes step S301g again, instead of step S101a. Further, in step S101c according to the present first example embodiment, the detection unit 204 may decide that the first gesture is not detected when the first gesture is not detected within a predetermined time.

When the trigger voice is detected (step S301i; Yes), subsequently, the detection unit 304 executes steps S101a to S101b, and then executes step S101c. Therefore, the detection unit 304 can detect the first gesture by processing image information being acquired after the trigger voice is detected.

When deciding that the first gesture is detected (step S101c; Yes), the detection unit 304 decides whether an input condition is satisfied (step S301d).

In more details, the detection unit 304 acquires a voice feature value of a person who utters the trigger voice, based on the voice including the trigger voice detected in step S301i. Further, the detection unit 304 refers to the gesture information 307a, and acquires an input condition associated with the first gesture detected in step S101c. In the present example embodiment, the input condition acquired herein is a match with a voice feature value of an authorized person. Further, the input condition acquired herein also includes the voice feature value of the authorized person.

Therefore, the detection unit 304 compares the voice feature value of the person who utters the trigger voice with the voice feature value of the authorized person included in the input condition. The detection unit 304 decides whether the input condition is satisfied, according to a result of the comparison. In more details, when the compared voice feature values match, the detection unit 304 decides that the input condition is satisfied. When the compared voice feature values do not match, the detection unit 304 decides that the input condition is not satisfied.

For example, when the “gesture A” is detected in step S101c, referring to the gesture information 307a, the input condition associated with the “gesture A” is that a voice feature value of a person who utters the trigger voice matches a voice feature value of the person Pa (the authorized person).

When the person who utters the trigger voice “voice A” is the person Pa, the voice feature value of the person who utters the trigger voice and the voice feature value of the authorized person match. In this case, the detection unit 304 decides that the input condition is satisfied. Meanwhile, when the person who utters trigger voice “voice A” is the person Pb, the voice feature value of the person who utters the trigger voice and the voice feature value of the authorized person do not match. In this case, the detection unit 304 decides that the input condition is not satisfied.

When deciding that the input condition is not satisfied (step S301d; No), the detection unit 304 executes step S301g again.

When deciding that the input condition is satisfied (step S301d; Yes), the detection unit 304 returns to the control processing (see FIG. 2).

Then, a control unit 105 executes device control processing (step S102) similar to that in the first example embodiment. By executing such control processing, the device 102 can be controlled using the first gesture while using the trigger voice as a trigger.

The third example embodiment of the present invention has been described so far.

According to the present example embodiment, an input condition includes a condition that predetermined trigger voice is detected from voice information. Thereby, a person who is capable of controlling the device 102 using the first gesture can be limited to a person who utters the trigger voice, and a possibility that the device 102 is controlled in such a way that may impair convenience for a user can be reduced. Therefore, convenience for a user can be improved.

According to the present example embodiment, an input condition includes a condition related to a relation between a voice feature value of a person who utters trigger voice and a voice feature value of a predetermined authorized person. Thereby, a person who is capable of controlling the device 102 using a first gesture can be limited to the person who utters the trigger voice, and a possibility that device 102 is controlled in such a way that may impair convenience for a user can be reduced. Therefore, convenience for a user can be improved.

According to the present example embodiment, when detecting trigger voice from voice information, the detection unit 304 detects a first gesture by processing image information being acquired after the trigger voice is detected. Thereby, the first gesture can be detected from an image being acquired after the trigger voice is detected, and the trigger voice can be used as a trigger for controlling the device 102 using the first gesture.

Consequently, a time period when the device 102 can be controlled by using the first gesture can be limited to after the trigger voice is detected, and therefore a possibility that the device 102 is controlled by a motion with no intention of controlling the device 102 can be reduced. Specifically, a possibility that the device 102 is controlled in such a way that may impair convenience for a user can be reduced. Therefore, convenience for a user can be improved.

### Fourth Example Embodiment

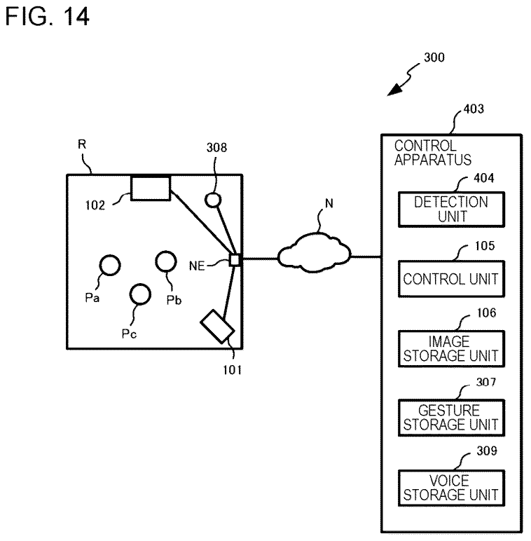

FIG. 14 is a diagram illustrating a configuration example of a control system 400 according to a fourth example embodiment of the present invention, together with a diagram illustrating one example of a subject space R in overhead view.

The control system 400 according to the present example embodiment includes a control apparatus 403 in place of the control apparatus 303 according to the third example embodiment. The control apparatus 403 includes a detection unit 404 in place of the detection unit 304 according to the third example embodiment. Except for these points, the control system 400 may similarly be configured as the control system 300 according to the third example embodiment.

The detection unit 404 includes a similar function to that of the detection unit 304 according to the third example embodiment. In addition to this, when detecting trigger voice from voice information, the detection unit 404 estimates an origin area of the trigger voice, based on the voice information. Then, the detection unit 404 detects a first gesture of a person in the estimated origin area, by processing image information acquired after the trigger voice is detected.

Physically, the control system 400 according to the present example embodiment may similarly be configured as the control system 300 according to the third example embodiment.

The control apparatus 303 executes detection processing (step S401) in place of the detection processing (step S101) in the control processing illustrated in FIG. 2. Except for this point, control processing according to the present example embodiment may be similar to the control processing according to the first example embodiment.

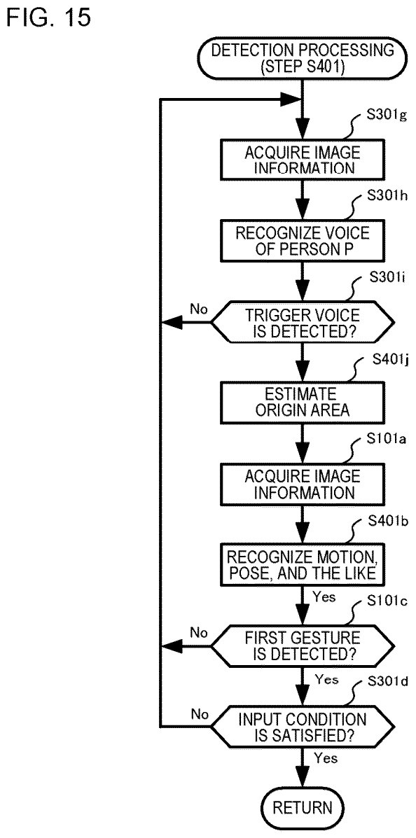

FIG. 15 is a flowchart illustrating one example of the detection processing (step S401).

The detection unit 404 executes steps S301g to S301i similar to those in the third example embodiment.

When deciding that the trigger voice is detected (step S301i; Yes), the detection unit 404 estimates an origin area of the trigger voice detected in step S301i (step S401j).

In more details, the detection unit 404 estimates an origin area of the trigger voice in a subject space R, based on a volume, a direction, and the like of the trigger voice detected in step S301i.

As in the third example embodiment, the detection unit 404 executes the step S101a.

The detection unit 404 recognizes a motion, a pose, and the like of a person P in the origin area estimated in step S401j, by processing image information (step S401b).

In more details, the detection unit 104 extracts, from the image information, an image of the origin area estimated in step S401j, by using one or a plurality of a face recognition function, a human form recognition function, a pose recognition function, a motion recognition function, an external appearance attribute recognition function, a gradient feature detection function of an image, a color feature detection function of an image, an object recognition function, an age group estimation function, and the like. By using similar functions, the detection unit 104 recognizes a pose, a motion, and the like of the person P.

As in the third example embodiment, the detection unit 404 executes steps S101c and 301d.

Herein, in step S401b, the detection unit 404 recognizes a motion, a pose, and the like of the person P in the origin area estimated in step S401j, by processing the image information acquired in step S101a. Then, in step S101c, the detection unit 404 detects a first gesture by using the motion, the pose, and the like of the person P recognized in step S401b.

Therefore, the detection unit 404 can detect the first gesture of the person in the origin area estimated in step S401j, by processing the image information acquired in step S101a.

As in the third example embodiment, when deciding that an input condition is not satisfied (step S301d; No), the detection unit 304 executes step S301g again. Further, when deciding that the input condition is satisfied (step S301d; Yes), the detection unit 304 returns to the control processing (see FIG. 2).

Then, a control unit 105 executes device control processing (step S102) similar to that in the first example embodiment. As in the third example embodiment, by executing such control processing, a device 102 can be controlled using the first gesture while using the trigger voice as a trigger.

According to the present example embodiment, when detecting trigger voice from voice information, the detection unit 404 estimates an origin area of the trigger voice, based on the voice information. The detection unit 404 detects a first gesture of the person P in the estimated origin area, by processing image information being acquired after the trigger voice is detected.

Thereby, a person who is capable of controlling the device 102 using the first gesture can be limited to a person in an area where the trigger voice is originated. In this case, it is highly likely that a person who controls the device 102 using the first gesture can be limited to a person who utters the trigger voice. Therefore, a possibility that the device 102 is controlled by a motion with no intention of controlling the device 102 can be reduced. Specifically, a possibility that the device 102 is controlled in such a way that may impair convenience for a user can be reduced. Therefore, convenience for a user can be improved.

While the example embodiments and the modification examples of the present invention have been described with reference to the drawings, these are exemplifications of the present invention, and various configurations other than the above-described configurations can also be employed.

Further, in a plurality of flowcharts referred to in the above description, a plurality of steps (pieces of processing) are described in order, but an execution order of the steps executed in each example embodiment is not limited to the described order. In each example embodiment, the illustrated order of the steps may be changed to an extent that contents thereof are not interfered. Further, each of the above-described example embodiments and modification examples may be combined to an extent that contents thereof do not conflict with each other.

A part or the entirety of the above-described example embodiments may be described as the following supplementary notes, but is not limited thereto.
1.

A control apparatus including:
a detection unit that detects a predetermined first gesture by processing image information; and
a control unit that controls, when an input condition being a condition for allowing control of a device using the first gesture is satisfied, the device according to the first gesture.
2.

The control apparatus according to supplementary note 1, wherein
the input condition includes a condition related to an image feature value of a person who makes the first gesture.
3.

The control apparatus according to supplementary note 2, wherein
the input condition includes a condition related to a relation between an image feature value of a person who makes the first gesture and an image feature value of a predetermined authorized person.
4.

The control apparatus according to supplementary note 3, wherein
the detection unit detects a predetermined second gesture by processing the image information, and
the input condition includes a condition related to a relation between an image feature value of a person who makes the first gesture and an image feature value of a person who makes the second gesture.
5.

The control apparatus according to supplementary note 4, wherein,
when detecting the second gesture, the detection unit detects the first gesture, based on the image information acquired after the second gesture is detected.
6.

The control apparatus according to any one of supplementary notes 1 to 5, wherein
the input condition includes a condition that predetermined trigger voice is detected from voice information.
7.

The control apparatus according to supplementary note 6, wherein
the input condition further includes a condition related to a voice feature value of a person who utters the trigger voice.
8.

The control apparatus according to supplementary note 7, wherein
the input condition includes a condition related to a relation between a voice feature value of a person who utters the trigger voice and a voice feature value of a predetermined authorized person.
9.

The control apparatus according to supplementary notes 6 to 8, wherein,
when detecting the trigger voice from the voice information, the detection unit detects the first gesture by processing the image information acquired after the trigger voice is detected.
10.

The control apparatus according to supplementary note 9, wherein,
when detecting the trigger voice from the voice information, the detection unit estimates an origin area of the trigger voice, based on the voice information, and detects the first gesture of a person in the estimated origin area, by processing the image information acquired after the trigger voice is detected.
11.

A control system including:
the control apparatus according to any one of supplementary notes 1 to 10;
an imaging apparatus that generates the image information; and
the device.
12.

A control method including,
by a computer:
detecting a predetermined first gesture by processing image information; and
controlling, when an input condition being a condition for allowing control of a device using the first gesture is satisfied, the device according to the first gesture.
13.

A program for causing a computer to execute:
detecting a predetermined first gesture by processing image information; and
controlling, when an input condition being a condition for allowing control of a device using the first gesture is satisfied, the device according to the first gesture.

### REFERENCE SIGNS LIST

100, 200, 300.400 Control system
101 Imaging apparatus
102 Device
103, 203, 303, 403 Control apparatus
104, 204, 304, 404 Detection unit
105 Control unit
106 Image storage unit
107, 207, 307 Gesture storage unit
107a, 207a, 307a Gesture information
308 Voice detection apparatus
309 Voice storage unit
P, Pa, Pb, Pc Person
R Subject space

What is claimed is:

1. A control apparatus comprising:
at least one memory configured to store instructions; and
at least one processor configured to execute the instructions to perform operations comprising:
detecting a predetermined first gesture by processing image information; and
controlling, when an input condition being a condition for allowing control of a device using the first gesture is satisfied, the device according to the first gesture.

2. The control apparatus according to claim 1, wherein
the input condition includes a condition related to an image feature value of a person who makes the first gesture.

3. The control apparatus according to claim 2, wherein
the input condition includes a condition related to a relation between an image feature value of a person who makes the first gesture and an image feature value of a predetermined authorized person.

4. The control apparatus according to claim 3, the operations further comprising
detecting a predetermined second gesture by processing the image information, and wherein
the input condition includes a condition related to a relation between an image feature value of a person who makes the first gesture and an image feature value of a person who makes the second gesture.

5. The control apparatus according to claim 4, wherein,
when detecting the second gesture, the first gesture is detected, based on the image information acquired after the second gesture is detected.

6. The control apparatus according claim 1, wherein
the input condition includes a condition that predetermined trigger voice is detected from voice information.

7. The control apparatus according to claim 6, wherein
the input condition further includes a condition related to a voice feature value of a person who utters the trigger voice.

8. The control apparatus according to claim 7, wherein
the input condition includes a condition related to a relation between a voice feature value of a person who utters the trigger voice and a voice feature value of a predetermined authorized person.

9. The control apparatus according to claim 6, wherein,
when detecting the trigger voice from the voice information, the first gesture is detected by processing the image information acquired after the trigger voice is detected.

10. The control apparatus according to claim 9, wherein,
when detecting the trigger voice from the voice information, an origin area of the trigger voice is estimated, based on the voice information, and the first gesture of a person in the estimated origin area is detected, by processing the image information acquired after the trigger voice is detected.

11. A control system comprising:
the control apparatus according to claim 1;
an imaging apparatus that generates the image information; and
the device.

12. A control method comprising,
by a computer:
detecting a predetermined first gesture by processing image information; and
controlling, when an input condition being a condition for allowing control of a device using the first gesture is satisfied, the device according to the first gesture.

13. A non-transitory computer readable storage medium storing a program for causing a computer to execute:
detecting a predetermined first gesture by processing image information; and
controlling, when an input condition being a condition for allowing control of a device using the first gesture is satisfied, the device according to the first gesture.
